(19) United States
(12) Patent Application Publication
(10) Pub. No.: US 2025/0271736 A1
(43) Pub. Date: Aug. 28, 2025

(54) PROJECTOR

(71) Applicant: SEIKO EPSON CORPORATION, Tokyo (JP)

(72) Inventor: Kohei NAKAZAKI, MATSUMOTO-SHI (JP)

(21) Appl. No.: 19/063,875

(22) Filed: Feb. 26, 2025

(30) Foreign Application Priority Data
Feb. 28, 2024 (JP) 2024-028239

(51) Int. Cl. G03B 21/00; G02B 5/26; G03B 21/20; G03B 33/12

(52) U.S. Cl. CPC G03B 21/005; G02B 5/26; G03B 21/2013; G03B 21/204; G03B 21/206; G03B 21/2073; G03B 33/12

(57) ABSTRACT

A projector includes a first light source apparatus including a first light emitter configured to emit first color light and a first wavelength converter configured to convert part of the first color light from the first light emitter into second color light, the first light source apparatus configured to output third color light containing the first color light and the second color light; a first light guide including a first light incident end part on which the third color light output from the first light source apparatus is incident, a first light exiting end part via which the third color light incident via the first light incident end part exits, and a first reflection surface having an inner surface configured to reflect the third color light incident via the first light incident end part; a first filter disposed at a position facing a light exiting side of the first light guide and configured to transmit first-wavelength color light out of the third color light and reflect second-wavelength color light out of the third color light toward the first light guide; a first light modulator configured to modulate the first-wavelength color light to form a projection image; and a projection lens configured to project the projection image in a form of an enlarged image.

The present application is based on, and claims priority from JP Application Serial Number 2024-028239, filed Feb. 28, 2024, the disclosure of which is hereby incorporated by reference herein in its entirety.

### BACKGROUND

### 1. Technical Field

The present disclosure relates to a projector.

### 2. Related Art

A projector using light emitting diodes as a light source apparatus is described in JP-A-2000-180962. A projector described in JP-A-2000-180962 includes three light emitting diodes, three light modulators corresponding to the three light emitting diodes, a dichroic prism that combines three types of modulated light output from the three light modulators with one another into one type of modulated light, and a projection lens that projects the combined modulated light in the form of an enlarged image.

JP-A-2000-180962 is an example of the related art.

A light emitting diode includes in some cases a light emitter that emits first color light and a light converter that converts part of the first color light from the light emitter into second color light. The light emitting diode emits third color light containing the first color light and the second color light. For example, when the light emitting diode emits green light as the third color, the light emitter emits blue light as the first color light. The light converter is a fluorescent layer, and converts part of the blue light into green light as the second color light. The green light as the third color light includes in some cases color light having an unwanted wavelength band, such as intermediate color light having a wavelength band between those of the green light and the blue light and intermediate color light having the wavelength band between those of the green light and the red light. As described above, when the third color light containing the first color light and the second color light, into which the first color light is converted, contains color light having an unwanted wavelength band, there is a problem of a decrease in color reproducibility of an image enlarged and projected by the projector.

### SUMMARY

To solve the problem described above, a projector according to an aspect of the present disclosure includes: a first light source apparatus including a first light emitter configured to emit first color light and a first wavelength converter configured to convert part of the first color light from the first light emitter into second color light, the first light source apparatus configured to output third color light containing the first color light and the second color light; a first light guide including a first light incident end part on which the third color light output from the first light source apparatus is incident, a first light exiting end part via which the third color light incident via the first light incident end part exits, and a first reflection surface having an inner surface configured to reflect the third color light incident via the first light incident end part; a first filter disposed at a position facing a light exiting side of the first light guide and configured to transmit first-wavelength color light out of the third color light and reflect second-wavelength color light out of the third color light toward the first light guide; a first light modulator configured to modulate the first-wavelength color light to form a projection image; and a projection lens configured to project the projection image in a form of an enlarged image.

### BRIEF DESCRIPTION OF THE DRAWINGS

FIG. 1 is a schematic view of key parts of a projector according to a first embodiment.

FIG. 2 illustrates the function of a first filter.

FIG. 3 illustrates a frame member that constitutes a first light guide.

FIG. 4 is a schematic view of key parts of a projector according to a first variation of the first embodiment.

FIG. 5 is a schematic view of key parts of a projector according to a second variation of the first embodiment.

FIG. 6 is a descriptive diagram showing key parts of a projector according to a second embodiment.

### DESCRIPTION OF EMBODIMENTS

A projector according to each embodiment of the present disclosure will be described below with reference to the drawings.

### First Embodiment

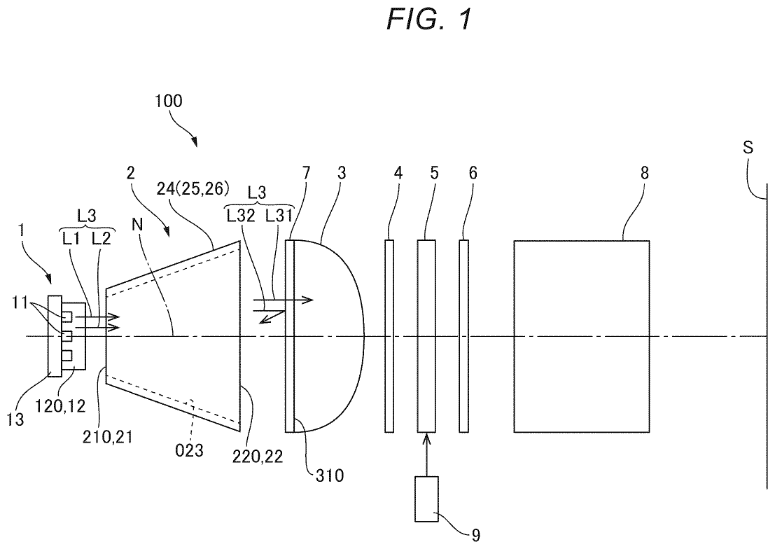

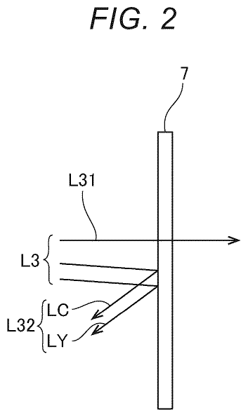

FIG. 1 is a schematic view of key parts of a projector 100 according to a first embodiment. FIG. 2 illustrates the function of a first filter 7. The projector 100 projects an enlarged image onto a screen S, as shown in FIG. 1. The projector 100 includes a first light source apparatus 1, a first light guide 2, the first filter 7, a first parallelizing element 3, a first polarizer 4, a first light modulator 5, a second polarizer 6, a projection lens 8, and a controller 9.

The first light source apparatus 1 includes first light emitters 11, which each emit first color light L1, and a first wavelength converter 12, which converts part of the first color light L1 from each of the first light emitters 11 into second color light L2. The first light source apparatus 1 outputs third color light L3 containing the first color light L1 and the second color light L2.

The first light emitters 11 are each an LED device. In the present embodiment, the first light emitters 11 each emit blue light as the first color light L1. The wavelength band of the blue light ranges, for example, from 420 nm to 490 nm.

The first wavelength converter 12 is a fluorescent layer 120. In the present embodiment, the fluorescent layer 120 is a red and green fluorescent layer. The fluorescent layer 120 is excited by the blue light emitted from the first light emitters 11, and converts the blue light into red light and green light that form the second color light L2. The wavelength band of the red light ranges, for example, from 590 nm to 680 nm. The wavelength band of the green light ranges, for example, from 490 nm to 590 nm. In the present embodiment, the third color light L3 output by the first light source apparatus 1 is therefore white light. The wavelength band of the white light ranges, for example, from 420 nm to 680 nm.

The first light guide 2 has an inner surface that reflects the third color light L3 incident from the first light source apparatus 1, and outputs the resultant third color light L3. The first filter 7 is disposed at a position facing the light exiting side of the first light guide 2. The first filter 7 is a bandpass filter. The first filter 7 transmits first-wavelength color light L31 out of the third color light L3 and reflects second-wavelength color light L32 out of the third color light L3 toward the first light guide 2, as shown in FIG. 2. In the present embodiment, the first-wavelength color light L31 is white light containing blue light having wavelengths from 420 nm to 470 nm, green light having wavelengths from 490 nm to 570 nm, and red light having wavelengths from 590 nm to 680 nm. The second-wavelength color light L32 is mixed light containing first intermediate color light LC having wavelengths from 470 nm to 490 nm and second intermediate color light LY having wavelengths from 570 nm to 590 nm. That is, the first intermediate color light LC is light having a color between blue and green, and the second intermediate color light LY is light having a color between green and red. Note that the first intermediate color light LC corresponds to the third-wavelength color light in the present disclosure, and that the second intermediate color light LY corresponds to the fourth-wavelength color light in the present disclosure.

The first parallelizing element 3 is disposed between the first light guide 2 and the first polarizer 4. The first parallelizing element 3 parallelizes the first-wavelength color light L31 output from the first light guide 2. The first parallelizing element 3 is, for example, a lens having a planar light incident surface 310 and a convex light exiting surface, as shown in FIG. 1. In the present embodiment, the first filter 7 is disposed at the light incident surface 310 of the first parallelizing element 3.

The first polarizer 4 reflects one of a P-polarized component (first polarized component) and an S-polarized component (second polarized component) out of the polarized components contained in the first-wavelength color light L31 output from the first parallelizing element 3, and transmits the other polarized component. In the present embodiment, the first polarizer 4 reflects the S-polarized component out of the polarized components contained in the first-wavelength color light L31 output from the first parallelizing element 3, and transmits the P-polarized component.

The first light modulator 5 modulates the first-wavelength color light L31 from the first polarizer 4 into modulated light to form a projection image. The first light modulator 5 is, for example, a liquid crystal panel 51. In the present embodiment, the liquid crystal panel 51 is configured with a single panel, and has pixels corresponding to the multiple types of color light. In the thus configured liquid crystal panel 51, the pixels, which correspond to the multiple types of color light, modulate the first-wavelength color light L31, which is white light, to form full-color image light.

The second polarizer 6 is disposed at a position facing the light exiting side of the first light modulator 5 and transmits one of the P-polarized component (first polarized component) and the S-polarized component (second polarized component) out of the polarized components contained in the modulated light output from the first light 5. In the present embodiment, the second modulator polarizer 6 transmits the S-polarized component out of the polarized components contained in the modulated light output from the first light modulator 5.

The projection lens 8 includes multiple lenses. The projection lens 8 enlarges the projection image and projects the enlarged image onto the screen S. The controller 9 operates the first light modulator 5 based on an external image signal such as a video signal.

### First Light Guide

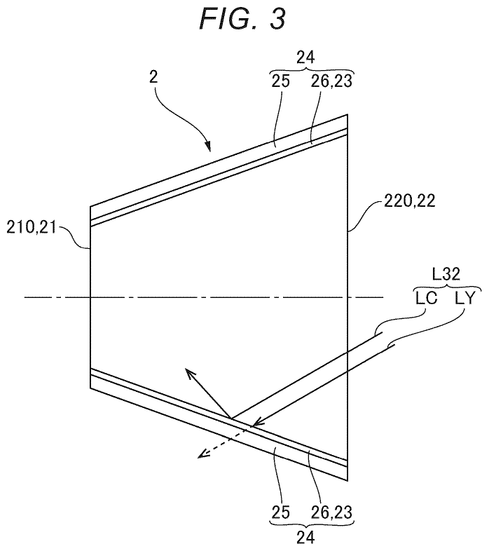

FIG. 3 illustrates a frame member 24, which constitutes the first light guide 2. The first light guide 2 includes a first light incident end part 21, on which the third color light L3 output from the first light source apparatus 1 is incident, a first light exiting end part 22, via which the third color light L3 incident via the first light incident end part 21 exits, and a first reflection surface 23, which has an inner surface that reflects the third color light L3 incident via the first light incident end part 21, as shown in FIG. 1.

The first light guide 2 has a hollow structure, and is a cylindrical reflector having openings provided at the first light incident end part 21 and the first light exiting end part 22. A first light incidence surface 210 is formed at the first light incident end part 21. A first light exiting surface 220 is formed at the first light exiting end part 22. The first light exiting surface 220 formed at the first light exiting end part 22 is larger than the first light incidence surface 210 formed at the first light incident end part 21, as shown in FIG. 1. The cross-partal area of the first light guide 2 taken along a plane perpendicular to an optical axis N of the first light guide 2 therefore increases as the first light guide 2 extends from the first light incident end part 21 toward the first light exiting end part 22. In the present embodiment, the first light guide 2 taken along the plane perpendicular to the optical axis N has a rectangular cross-partal shape.

The first light guide 2 is configured with the plate-shaped frame member 24. The frame member 24 includes a first base 25 and a first reflection film 26 provided on the first base 25. The first reflection film 26 is the first reflection surface 23. The first reflection film 26 is a bandpass filter, reflects the first intermediate color light LC, and transmits the second intermediate color light LY. The first base 25 is a bandpass filter and transmits and absorbs the second intermediate color light LY.

### Advantages and Effects

The projector 100 includes the first light source apparatus 1, the first light guide 2, the first filter 7, the first light modulator 5, and the projection lens 8. The first light source apparatus 1 includes the first light emitters 11, which each emit blue light, and the first wavelength converter 12, which converts part of the blue light from each of the first light emitters 11 into green light and red light, and outputs white light containing the blue light, the green light, and the red light. The first light guide 2 includes the first light incident end part 21, on which the white light output from the first light source apparatus 1 is incident, the first light exiting end part 22, via which the white light incident via the first light incident end part 21 exits, and the first reflection surface 23, which has an inner surface that reflects the white light incident via the first light incident end part 21. The first filter 7 is disposed at a position facing the light exiting side of the first light guide 2, transmits the first-wavelength color light L31 out of the white light, and reflects the second-wavelength color light L32 out of the white light toward the first light guide 2. The first light modulator 5 modulates the first-wavelength color light L31 to form a projection image. The projection lens 8 projects the projection image in the form of an enlarged image.

The second-wavelength color light L32 contains the third-wavelength color light and the fourth-wavelength color light. The third-wavelength color light is the first intermediate color light LC having a color between blue and green. The fourth-wavelength color light is the second intermediate color light LY having a color between green and red.

In the projector 100 according to the present embodiment, the first filter 7 transmits the first-wavelength color light L31 containing the blue light having wavelengths ranging 420 nm to 470 nm, the green light having wavelengths ranging 490 nm to 570 nm, and the red light having wavelengths ranging from 590 nm to 680 nm, and reflects the second-wavelength color light L32 containing the first intermediate color light LC having wavelengths ranging 470 nm to 490 nm and the second intermediate color light LY having wavelengths ranging from 570 nm to 590 nm toward the first light guide 2, so that the color reproducibility of the enlarged image projected onto the screen S is improved.

The first light guide 2 includes the first base 25 and the first reflection film 26 provided on the first base 25. The first reflection film 26 is the first reflection surface 23. The first reflection film 26 reflects the first intermediate color light LC, and transmits the second intermediate color light LY. The first base 25 transmits or absorbs the second intermediate color light LY. The first intermediate color light LC reflected off the first reflection film 26 therefore excites the fluorescent layer 120 again, is converted into green light, and reaches the first filter 7, so that the optical intensity of the green light contained in the first-wavelength color light L31 is increased. As a result, the brightness of the enlarged image increases, and the color reproducibility of the enlarged image is improved. The first base 25 eliminates the second intermediate color light LY, which hardly excites the fluorescent layer 120, and can therefore prevent the second intermediate color light LY from remaining between the first light source apparatus 1 and the first filter 7. As a result, the second intermediate color light LY is unlikely to cause the first light guide 2 and the first filter 7 to generate heat, so that the durability of the first light guide 2 and the first filter 7 is improved.

The projector 100 includes the first parallelizing element 3, which is disposed between the first light guide 2 and the first light modulator 5 and parallelizes the first-wavelength color light L31 output from the first light guide 2. The first filter 7 is disposed at the light incident surface 310 of the first parallelizing element 3. The first-wavelength color light L31 that enters the first light modulator 5 can thus be parallelized. Furthermore, integrating the first filter 7 and the first parallelizing element 3 with each other allows reduction in size of the projector 100.

The first light guide 2 taken along a plane perpendicular to the optical axis N of the first light guide 2 has a rectangular cross-partal shape. The first-wavelength color light L31 that exits via the first light exiting surface 220 can thus be a rectangular luminous flux, so that the first light guide 2 can efficiently illuminate the first light modulator 5 with the first-wavelength color light L31.

The first light exiting surface 220 formed at the first light exiting end part 22 is larger than the first light incidence surface 210 formed at the first light incident end part 21. The first light guide 2 can therefore expand the luminous flux while homogenizing the illuminance distribution of the first-wavelength color light L31.

### Variations of First Embodiment

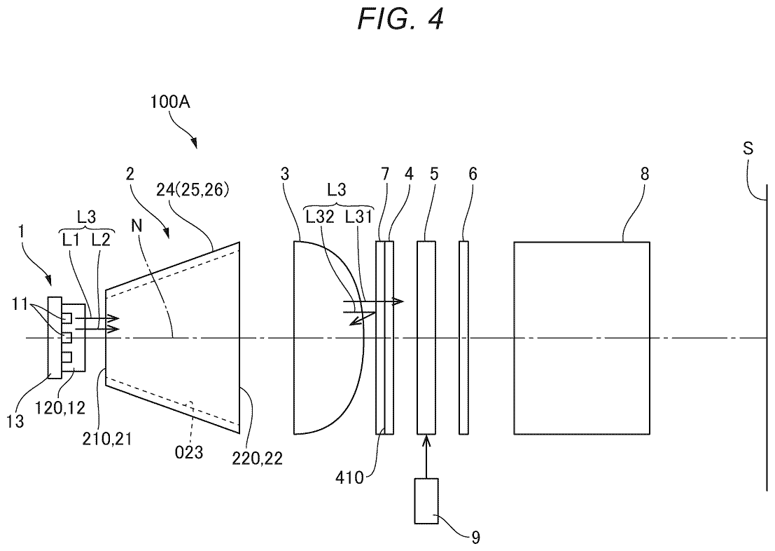

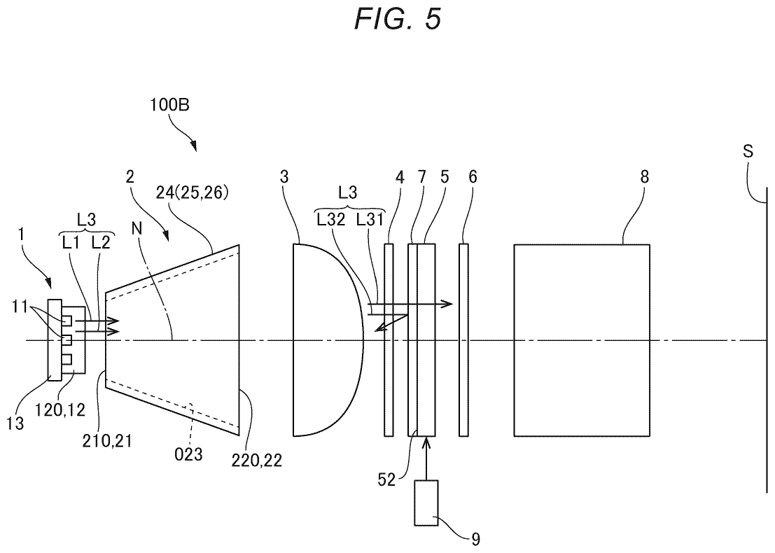

FIG. 4 is a schematic view of key parts of a projector 100A according to a first variation of the first embodiment. FIG. 5 is a schematic view of key parts of a projector 100B according to a second variation of the first embodiment.

In the projector 100A according to the first variation, the first filter 7 is disposed at a light incident surface 410 of the first polarizer 4, as shown in FIG. 4. The third color light L3 that enters the first filter 7 is parallelized therefore by the first parallelizing element 3, so that optical loss that occurs when the third color light L3 passes through the first filter 7 is smaller than that in the case where the third color light L3 is not parallelized.

In the projector 100B according to the second variation, the first filter 7 is disposed at a light incident surface 52 of the first light modulator 5, as shown in FIG. 5. The first polarizer 4 reflects one of the P-polarized component (first polarized component) and the S-polarized component (second polarized component) out of the polarized components contained in the third color light L3 output from the first parallelizing element 3, and transmits the other polarized component. The third color light L3 that enters the first filter 7 therefore contains only one of the P-polarized component and the S-polarized component, so that the optical intensity of the third color light L3 that enters the first filter 7 is lower than that in the case of color light containing all the polarized components, which are the P polarized component and the S polarized component. As a result, the amount of light received by the first filter 7 decreases, so that the durability of the first filter 7 is improved.

### Second Embodiment

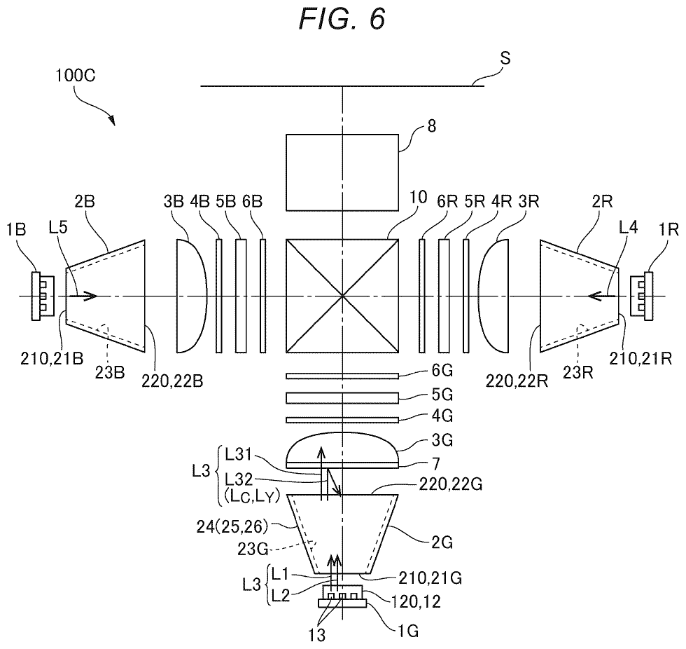

FIG. 6 is a descriptive diagram showing key parts of a projector 100C according to a second embodiment. The projector 100C according to the second embodiment is a three-plate projector, as shown in FIG. 6. The projector 100C includes a first light source apparatus 1G, a first light guide 2G, a first parallelizing element 3G, the first filter 7, a first polarizer 4G, a first light modulator 5G, a second polarizer 6G, a second light source apparatus 1R, a second light guide 2R, a second parallelizing element 3R, a first polarizer 4R, a second light modulator 5R, a second polarizer 6R, a third light source apparatus 1B, a third light guide 2B, a third parallelizing element 3B, a first polarizer 4B, a third light modulator 5B, a second polarizer 6B, a light combiner 10, the projection lens 8, and a controller. The controller operates the first light modulator 5G, the second light modulator 5R, and the third light modulator 5B based on an external image signal such as a video signal.

The first light source apparatus 1G includes the first light emitters 11, which each emit the first color light L1, and the first wavelength converter 12, which converts part of the first color light L1 from each of the first light emitters 11 into the second color light L2. The first light source apparatus 1G outputs the third color light L3 containing the first color light L1 and the second color light L2.

The first light emitters 11 are each an LED device. In the present embodiment, the first light emitters 11 each emit blue light as the first color light L1. The wavelength band of the blue light ranges, for example, from 420 nm to 490 nm.

The first wavelength converter 12 is the fluorescent layer 120. In the present embodiment, the fluorescent layer 120 is a green fluorescent layer. The fluorescent layer 120 converts the blue light emitted from the first light emitters 11 into green light, which is the second color light L2. In the present embodiment, the third color light L3 output by the first light source apparatus 1G is green light. The wavelength band of the green light ranges, for example, from 470 nm to 590 nm, and contains a portion of the wavelength band of the blue light.

The second light source apparatus 1R outputs fourth color light L4 different from the third color light L3. The third light source apparatus 1B outputs fifth color light L5 different from the third color light L3 and the fourth color light L4. The second light source apparatus 1R and the third light source apparatus 1B are each an LED light source. The fourth color light L4 is red light. The wavelength band of the red light ranges, for example, from 590 nm to 680 nm. The fifth color light L5 is blue light. The wavelength band of the blue light ranges, for example, from 420 nm to 490 nm.

The first light guide 2G has an inner surface that reflects the third color light L3 incident from the first light source apparatus 1G, and outputs the resultant third color light L3. The first light guide 2G is configured in the same manner as the first light guide 2 in the first embodiment. The first light guide 2G will therefore not be described in detail. The first intermediate color light LC reflected off the first reflection film 26 therefore excites the fluorescent layer 120 again, is converted into green light, and reaches the first filter 7, so that the optical intensity of the green light contained in the first-wavelength color light L31 is increased. The first base 25 eliminates the second intermediate color light LY, which hardly excites the fluorescent layer 120, and can therefore prevent the second intermediate color light LY from remaining between the first light source apparatus 1G and the first filter 7.

The second light guide 2R includes a second light incident end part 21R, on which the fourth color light L4 output from the second light source apparatus 1R is incident, a second light exiting end part 22R, via which the fourth color light L4 incident via the second light incident end part 21R exits, and a second reflection surface 23R, which has an inner surface that reflects the fourth color light L4 incident via the second light incident end part 21R. The third light guide 2B includes a third light incident end part 21B, on which the fifth color light L5 output from the third light source apparatus 1B is incident, a third light exiting end part 22B, via which the fifth color light L5 incident via the third light incident end part 21B exits, and a third reflection surface 23B, which has an inner surface that reflects the fifth color light L5 incident via the third light incident end part 21B. The second light guide 2R and the third light guide 2B may be configured in the same manner as or differently from the first light guide 2G.

The first filter 7 is disposed at a position facing the light exiting side of the first light guide 2G. The first filter 7 is a bandpass filter. The first filter 7 transmits the first-wavelength color light L31 out of the third color light L3 and reflects the second-wavelength color light L32 out of the third color light L3 toward the first light guide 2. In the present embodiment, the first-wavelength color light L31 is green light having wavelengths ranging from 490 nm to 570 nm. The second-wavelength color light L32 is mixed light containing the first intermediate color light LC having wavelengths ranging from 470 nm to 490 nm and the second intermediate color light LY having wavelengths ranging from 570 nm to 590 nm. Note that the first intermediate color light LC corresponds to the third-wavelength color light in the present disclosure, and that the second intermediate color light LY corresponds to the fourth-wavelength color light in the present disclosure.

The first parallelizing element 3G parallelizes the first-wavelength color light L31 output from the first light guide 2G. The first filter 7 is disposed at the light incident surface of the first parallelizing element 3G. The second parallelizing element 3R parallelizes the fourth color light L4 output from the second light guide 2R. The third parallelizing element 3B parallelizes the fifth color light L5 output from the third light guide 2B.

The first polarizers 4G, 4R, and 4B reflect one of the P-polarized component (first polarized component) and the S-polarized component (second polarized component) out of the polarized components contained in the color light output from the parallelizing elements 3G, 3R, and 3B, and transmits the other polarized component.

The first light modulator 5G modulates the first-wavelength color light L31 into modulated light to form a green projection image. The second light modulator 5R modulates the fourth color light L4 into modulated light to form a red projection image. The third light modulator 5B modulates the fifth color light L5 into modulated light to form a blue projection image. The light modulators 5G, 5R, and 5B are each a liquid crystal panel.

The second polarizers 6G, 6R, and 6B reflect one of the P-polarized component (first polarized component) and the S-polarized component (second polarized component) out of the polarized components contained in the modulated light output from the light modulators 5G, 5R, and 5B, and transmits the other polarized component.

The multiple types of modulated light from the light modulators 5G, 5R, and 5B enter the light combiner 10 in different directions. The projector 100C projects a full-color projection image output from the light combiner 10 onto the screen S in the form of an enlarged image.

### Advantages and Effects

In the projector 100C according to the second embodiment, since the first filter 7 is disposed at a position facing the light exiting side of the first light source apparatus 1G, which outputs green light, the green light contained in the combined modulated light from the light combiner 10 has optical intensity higher than that, for example, in a case where the first filter 7 is disposed at a position facing the light exiting side of the second light source apparatus 1R. The green light contained in the modulated light projected from the projector 100C therefore has high optical intensity, so that the enlarged, projected image becomes a vivid image, and the color reproducibility of the enlarged image is improved.

### Other Embodiments

In the embodiments described above, the first filter 7 is provided at the light incident surface of the first parallelizing element 3, the first polarizer 4, or the first light modulator 5, and may instead be a member independent of the first parallelizing element 3, the first polarizer 4, and the first light modulator 5.

In the embodiments described above, the first reflection film 26 reflects the first intermediate color light LC and transmits the second intermediate color light LY, and may instead reflect the first intermediate color light LC and the second intermediate color light LY. That is, the first reflection film 26 may reflect the color light across the entire wavelength range.

In the first embodiment, the first filter 7 reflects the color light having wavelengths ranging from 470 nm to 490 nm and the color light having wavelengths ranging from 570 nm to 590 nm, which form the second-wavelength color light L32, and may instead reflect only the color light having wavelengths ranging from 470 nm to 490 nm. Even in this case, the optical intensity of the green light contained in the first-wavelength color light L31 increases, so that the brightness of the enlarged image increases, and the color reproducibility of the enlarged image is improved.

In the first embodiment, the first filter 7 reflects the color light having wavelengths ranging from 470 nm to 490 nm and the color light having wavelengths ranging from 570 nm to 590 nm, which form the second-wavelength color light L32, and may further reflect color light having another wavelength band. For example, the first filter 7 may reflect color light having wavelengths ranging from 420 nm to 440 nm as the other wavelength band. In this case, short-wavelength blue light is removed from the third color light L3, so that the first light modulator 5 is unlikely to deteriorate due to the short-wavelength blue light.

In the second embodiment, the first light source apparatus 1G outputs the third color light L3 containing blue light and green light, and may instead output another type of color light. For example, the first light source apparatus 1G may output the third color light L3 containing blue light and red light. In this case, the first filter 7 may reflect the color light having the wavelengths between those of the blue light and the red light (second-wavelength color light) toward the first light guide 2.

In the second embodiment, the first filter 7 is disposed at a position facing the light exiting side of the first light guide 2G, and may be disposed at a position facing the light exiting side of each of the second light guide 2R and the third light guide 2B as needed.

### Summary of Present Disclosure

The present disclosure will be summarized below as additional remarks.

### Additional Remark 1

A projector including:
a first light source apparatus including a first light emitter configured to emit first color light and a first wavelength converter configured to convert part of the first color light from the first light emitter into second color light, the first light source apparatus configured to output third color light containing the first color light and the second color light;
a first light guide including a first light incident end part on which the third color light output from the first light source apparatus is incident, a first light exiting end part via which the third color light incident via the first light incident end part exits, and a first reflection surface having an inner surface configured to reflect the third color light incident via the first light incident end part;
a first filter disposed at a position facing a light exiting side of the first light guide and configured to transmit first-wavelength color light out of the third color light and reflect second-wavelength color light out of the third color light toward the first light guide;
a first light modulator configured to modulate the first-wavelength color light to form a projection image; and
a projection lens configured to project the projection image in a form of an enlarged image.

The second-wavelength color light is therefore removed from the third color light, so that the color reproducibility of the enlarged, projected image is improved. Furthermore, the second-wavelength color light reflected off the first light guide is converted again into the second color light by the first wavelength converter, and then reaches the first filter, so that the optical intensity of the third color light increases.

### Additional Remark 2

The projector according to Additional Remark 1, further including a first parallelizing element disposed between the first light guide and the first light modulator and configured to parallelize the first-wavelength color light output from the first light guide.

The first-wavelength color light that enters the first light modulator can thus be parallelized.

### Additional Remark 3

The projector according to Additional Remark 2, wherein the first filter is disposed at a light incident surface of the first parallelizing element.

The first filter and the first parallelizing element are thus integrated with each other, so that the size of the projector is reduced.

### Additional Remark 4

The projector according to Additional Remark 2, further including
a first polarizer disposed 1 between the first parallelizing element and the first light modulator and configured to transmit a first polarized component out of polarized components contained in the first-wavelength color light and reflect a second polarized component out of the polarized components contained in the first-wavelength color light,
wherein the first filter is disposed at a light incident surface of the first polarizer.

Therefore, since the third color light that enters filter is parallelized by the first parallelizing element, optical loss that occurs when the third color light passes through the first filter is smaller than the optical loss that occurs when the third color light is not parallelized.

### Additional Remark 5

The projector according to Additional Remark 2, further including
a first polarizer disposed between the first parallelizing element and the first light modulator and configured to transmit a first polarized component out of polarized components contained in the first-wavelength color light and reflect a second polarized component out of the polarized components contained in the first-wavelength color light,
wherein the first filter is disposed at a light incident surface of the first light modulator.

The third color light that enters the first filter is therefore only one of f the first polarized component and the second polarized component, so that the optical intensity of the third color light that enters the first filter is lower than the optical intensity provided when third color light containing all the polarized components, which are the first polarized component and the second polarized component. As a result, the amount of light received by the first filter is reduced, so that the durability of the first filter is improved.

### Additional Remark 6

The projector according to any one of Additional Remarks 1 to 5, wherein
the first color light is blue light,
the third color light is white light, and
the second-wavelength color light contains first intermediate color light having a color between blue and green.

The unwanted first intermediate color light is thus removed from the white light, so that the color reproducibility of the full-color enlarged image is improved.

### Additional Remark 7

The projector according to any one of Additional Remarks 1 to 5, further including:
a second light source apparatus configured to output fourth color light different from the third color light;
a third light source apparatus configured to output fifth color light different from the third color light and the fourth color light;
a second light guide including a second light incident end part on which the fourth color light output from the second light source apparatus is incident, and a second light exiting end part via which the fourth color light incident via the second light incident end part exits, a second reflection surface having an inner surface configured to reflect the fourth color light incident via the second light incident end part;
a third light guide including a third light incident end part on which the fifth color light output from the third light source apparatus is incident, and a third light exiting end part via which the fifth color light incident via the third light incident end part exits, a third reflection surface having an inner surface configured to reflect the fifth color light incident via the third light incident end part;
a second light modulator configured to modulate the fourth color light to form a projection image; and
a third light modulator configured to modulate the fifth color light to form a projection image.

The configured three-plate projector provides improved color reproducibility of a full-color enlarged image.

### Additional Remark 8

The projector according to Additional Remark 7, wherein
the first color light is blue light,
the second color light is green light, and
the second-wavelength color light is blue light.

The blue light is thus removed from the third color light, so that the color reproducibility of the enlarged image is improved.

### Additional Remark 9

The projector according to any one of Additional Remarks 1 to 8, wherein the first light guide taken along a plane perpendicular to an optical axis of the first light guide has a rectangular cross-partal shape.

The first-wavelength color light output from the first light guide can thus be a rectangular luminous flux, so that the first light guide can efficiently illuminate the first light modulator with the first-wavelength color light.

### Additional Remark 10

The projector according to Additional Remark 9, wherein a first light exiting surface formed at the first light exiting end part is larger than a first light incident surface formed at the first light incident end part.

The first light guide can thus expand the luminous flux while homogenizing the illuminance distribution of the first-wavelength color light.

### Additional Remark 11

The projector according to any one of Additional Remarks 1 to 5, wherein
the first light guide includes a first base and a first reflection film provided on the first base,
the first reflection film is the first reflection surface,
the second-wavelength color light contains third-wavelength color light and fourth-wavelength color light,
the first reflection film reflects the third-wavelength color light and transmits the fourth-wavelength color light, and
the base transmits or absorbs the fourth-wavelength color light.

Therefore, when the fourth-wavelength color light is certain-wavelength color light that is hardly converted again into the second color light by the first wavelength converter, the first base, which eliminates the fourth-wavelength color light, can prevent the fourth-wavelength color light from remaining between the first light source apparatus and the first filter. As a result, the fourth-wavelength color light is unlikely to cause the first light guide and the first filter to generate heat, so that the durability of the first light guide and the first filter is improved.

### Additional Remark 12

The projector according to Additional Remark 11, wherein
the third color light is white light,
the third-wavelength color light is first intermediate color light having a color between blue and green, and
the fourth-wavelength color light is a second intermediate color light having a color between green and red.

The first intermediate color light is therefore converted again into green light by the first wavelength converter, and then reaches the first filter, so that the optical intensity of the green light increases. As a result, the brightness of the enlarged image increases, and the color reproducibility of the enlarged image is improved. The first base eliminates the second intermediate color light, which is hardly converted into the second color light by the first wavelength converter, and can therefore prevent the second intermediate color light from remaining between the first light source apparatus and the first filter. As a result, the second intermediate color light is unlikely to cause the first light guide and the first filter to generate heat, so that the durability of the first light guide and the first filter is improved.

What is claimed is:

1. A projector comprising:
a first light source apparatus including a first light emitter configured to emit first color light and a first wavelength converter configured to convert part of the first color light from the first light emitter into second color light, the first light source apparatus configured to output third color light containing the first color light and the second color light;
a first light guide including a first light incident end part on which the third color light output from the first light source apparatus is incident, a first light exiting end part via which the third color light incident via the first light incident end part exits, and a first reflection surface having an inner surface configured to reflect the third color light incident via the first light incident end part;
a first filter disposed at a position facing a light exiting side of the first light guide and configured to transmit first-wavelength color light out of the third color light and reflect second-wavelength color light out of the third color light toward the first light guide;
a first light modulator configured to modulate the first-wavelength color light to form a projection image; and
a projection lens configured to project the projection image in a form of an enlarged image.

2. The projector according to claim 1, further comprising a first parallelizing element disposed between the first light guide and the first light modulator and configured to parallelize the first-wavelength color light output from the first light guide.

3. The projector according to claim 2, wherein the first filter is disposed at a light incident surface of the first parallelizing element.

4. The projector according to claim 2, further comprising:
a first polarizer disposed between the first parallelizing element and the first light modulator and configured to transmit a first polarized component out of polarized components contained in the first-wavelength color light and reflect a second polarized component out of the polarized components contained in the first-wavelength color light,
wherein the first filter is disposed at a light incident surface of the first polarizer.

5. The projector according to claim 2, further comprising
a first polarizer disposed between the first parallelizing element and the first light modulator and configured to transmit a first polarized component out of polarized components contained in the first-wavelength color light and reflect a second polarized component out of the polarized components contained in the first-wavelength color light,
wherein the first filter is disposed at a light incident surface of the first light modulator.

6. The projector according to claim 1, wherein
the first color light is blue light,
the third color light is white light, and
the second-wavelength color light contains first intermediate color light having a color between blue and green.

7. The projector according to claim 1, further comprising:
a second light source apparatus configured to output fourth color light different from the third color light;
a third light source apparatus configured to output fifth color light different from the third color light and the fourth color light;
a second light guide including a second light incident end part on which the fourth color light output from the second light source apparatus is incident, and a second light exiting end part via which the fourth color light incident via the second light incident end part exits, a second reflection surface having an inner surface configured to reflect the fourth color light incident via the second light incident end part;
a third light guide including a third light incident end part on which the fifth color light output from the third light source apparatus is incident, and a third light exiting end part via which the fifth color light incident via the third light incident end part exits, a third reflection surface having an inner surface configured to reflect the fifth color light incident via the third light incident end part;
a second light modulator configured to modulate the fourth color light to form a projection image; and
a third light modulator configured to modulate the fifth color light to form a projection image.

8. The projector according to claim 7, wherein
the first color light is blue light,
the second color light is green light, and
the second-wavelength color light is blue light.

9. The projector according to claim 1, wherein the first light guide taken along a plane perpendicular to an optical axis of the first light guide has a rectangular cross-partal shape.

10. The projector according to claim 9, wherein a first light exiting surface formed at the first light exiting end part is larger than a first light incident surface formed at the first light incident end part.

11. The projector according to claim 1, wherein
the first light guide includes a first base and a first reflection film provided on the first base,
the first reflection film is the first reflection surface,
the second-wavelength color light contains third-wavelength color light and fourth-wavelength color light,
the first reflection film reflects the third-wavelength color light and transmits the fourth-wavelength color light, and
the base transmits or absorbs the fourth-wavelength color light.

12. The projector according to claim 11, wherein
the third color light is white light,
the third-wavelength color light is first intermediate color light having a color between blue and green, and
the fourth-wavelength color light is a second intermediate color light having a color between green and red.
